(19) United States
(12) Patent Application Publication
(10) Pub. No.: US 2026/0179512 A1
(43) Pub. Date: Jun. 25, 2026

(54) Stereoscopic Image Display Apparatus

(71) Applicant: LG Display Co., Ltd., Seoul (KR)

(72) Inventors: Minsung Kang, Paju-si (KR); KiYol Chong, Paju-si (KR); Seongho Cho, Paju-si (KR); JaeKyu Park, Paju-si (KR)

(21) Appl. No.: 19/185,900

(22) Filed: Apr. 22, 2025

(30) Foreign Application Priority Data
Dec. 19, 2024 (KR) 10-2024-0190926

(51) Int. Cl. G09G 3/00; H04N 13/305

(52) U.S. Cl. CPC G09G 3/003; H04N 13/305; G09G 2300/0842; G09G 2310/0267

(57) ABSTRACT

A stereoscopic image display apparatus comprises a display panel including gate lines, on which a planar image or a stereoscopic image is displayed, a lens unit separating a left-eye image and a right-eye image output from the display panel, and a gate driver supplying gate pulses to the gate lines, wherein during a stereoscopic image display period in which a stereoscopic image is displayed on the display panel, the gate driver simultaneously supplies gate pulses to two gate lines that are spaced apart with two gate lines interposed therebetween.

### CROSS-REFERENCE TO RELATED APPLICATIONS

This application claims the benefit of the Republic of Korea Patent Application No. 10-2024-0190926 filed on Dec. 19, 2024, which is hereby incorporated by reference in its entirety.

### BACKGROUND

### Field of Technology

The present disclosure relates to a stereoscopic image display apparatus.

### Discussion of the Related Art

Display apparatuses are mounted on or provided in electronic products such as televisions, monitors, notebook computers, smart phones, tablet computers, electronic pads, wearable devices, watch phones, portable information devices, navigation devices, or vehicle control display devices, etc., to display images.

In particular, a stereoscopic image display apparatus can provide a stereoscopic image to a user, so a user can receive a more realistic image.

A stereoscopic image display apparatus can provide a two-dimensional image or a stereoscopic image based on a user's selection.

In order to display a two-dimensional image and a stereoscopic image, a driving frequency of a stereoscopic display apparatus can be changed.

However, it is difficult to change a driving frequency of a stereoscopic image display apparatus with a new structure by using a conventional driving frequency change method.

### SUMMARY

Accordingly, the present disclosure is directed to providing a stereoscopic image display apparatus that substantially obviates one or more problems due to limitations and disadvantages of the related art.

An embodiment of the present disclosure is directed to providing a stereoscopic image display apparatus in which gate pulses are simultaneously supplied to two gate lines spaced apart with two gate lines interposed therebetween during a stereoscopic image display period.

Additional advantages and features of the disclosure will be set forth in part in the description which follows and in part will become apparent to those having ordinary skill in the art upon examination of the following or can be learned from practice of the disclosure. The objectives and other advantages of the disclosure can be realized and attained by the structure particularly pointed out in the written description as well as the appended drawings.

To achieve these and other advantages and in accordance with the purpose of the disclosure, as embodied and broadly described herein, there is provided a stereoscopic image display apparatus comprising a display panel including gate lines, on which a planar image or a stereoscopic image is displayed, a lens unit separating a left-eye image and a right-eye image output from the display panel, and a gate driver supplying gate pulses to the gate lines, wherein during a stereoscopic image display period in which a stereoscopic image is displayed on the display panel, the gate driver simultaneously supplies gate pulses to two gate lines that are spaced apart with two gate lines interposed therebetween.

It is to be understood that both the foregoing general description and the following detailed description of the present disclosure are example and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is an exemplary diagram illustrating a configuration of a stereoscopic image display apparatus according to an embodiment of the present disclosure;

FIG. 2 is an exemplary diagram illustrating a structure of a sub-pixel applied to a stereoscopic image display apparatus according to an embodiment of the present disclosure;

FIG. 3 is an exemplary diagram illustrating a structure of a control driver applied to a stereoscopic image display apparatus according to an embodiment of the present disclosure;

FIG. 4 is an exemplary diagram illustrating a structure of a data driver applied to a stereoscopic image display apparatus according to an embodiment of the present disclosure;

FIG. 5 is an exemplary diagram illustrating a structure of a gate driver applied to a stereoscopic image display apparatus according to an embodiment of the present disclosure;

FIG. 6A is an exemplary diagram illustrating a portion of a display panel and a portion of a lens unit applied to a stereoscopic image display apparatus according to an embodiment of the present disclosure;

FIG. 6B is an enlarged exemplary diagram of a pixel and a convex lens illustrated in FIG. 6A according to an embodiment of the present disclosure;

FIG. 7 is another exemplary diagram illustrating a structure of a gate driver applied to a stereoscopic image display apparatus according to an embodiment of the present disclosure;

FIG. 8 is an exemplary diagram illustrating gate pulses output by the gate driver illustrated in FIG. 7 according to an embodiment of the present disclosure;

FIG. 9 is another exemplary diagram illustrating a structure of a gate driver applied to a stereoscopic image display apparatus according to an embodiment of the present disclosure; and

FIG. 10 is an exemplary diagram illustrating gate pulses output by the gate driver illustrated in FIG. 9 according to an embodiment of the present disclosure.

### DETAILED DESCRIPTION

Reference will now be made in detail to the exemplary embodiments of the present disclosure, examples of which are illustrated in the accompanying drawings. Wherever possible, the same reference numbers will be used throughout the drawings to refer to the same or like parts.

Advantages and features of the present disclosure, and implementation methods thereof will be clarified through following embodiments described with reference to the accompanying drawings. The present disclosure can, however, be embodied in different forms and should not be construed as limited to the embodiments set forth herein. Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details. Like reference numerals refer to like elements throughout. In the following description, when the detailed description of the relevant known function or configuration is determined to unnecessarily obscure the important point of the present disclosure, the detailed description will be omitted. When “comprise,” “have,” and “include” described in the present disclosure are used, another part can be added unless “only” is used. The terms of a singular form can include plural forms unless referred to the contrary.

In construing an element, the element is construed as including an error or tolerance range although there is no explicit description of such an error or tolerance range.

In describing a position relationship, for example, when a position relation between two parts is described as, for example, “on,” “over,” “under,” and “next,” one or more other parts can be disposed between the two parts unless a more limiting term, such as “just” or “direct(ly)” is used.

In describing a time relationship, for example, when the temporal order is described as, for example, “after,” “subsequent,” “next,” and “before,” a case that is not continuous can be included unless a more limiting term, such as “just,” “immediate(ly),” or “direct(ly)” is used.

It will be understood that, although the terms “first,” “second,” etc. can be used herein to describe various elements, these elements should not be limited by these terms. These terms are only used to distinguish one element from another and may not define order of sequence. For example, a first element could be termed a second element, and, similarly, a second element could be termed a first element, without departing from the scope of the present disclosure.

In describing elements of the present disclosure, the terms “first,” “second,” “A,” “B,” “(a),” “(b),” etc. can be used. These terms are intended to identify the corresponding elements from the other elements, and basis, order, or number of the corresponding elements should not be limited by these terms. The expression that an element is “connected,” “coupled,” or “adhered” to another element or layer should be understood the element or layer cannot only be directly connected or adhered to another element or layer, but also be indirectly connected or adhered to another element or layer with one or more intervening elements or layers “disposed,” or “interposed” between the elements or layers, unless otherwise specified.

The term “at least one” should be understood as including any and all combinations of one or more of the associated listed items. For example, the meaning of “at least one of a first item, a second item, and a third item” denotes the combination of all items proposed from two or more of the first item, the second item, and the third item as well as the first item, the second item, or the third item. Also, the term “can” used herein includes all meanings and definitions of the word “may”.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, embodiments of the present disclosure will be described in detail with reference to the accompanying drawings.

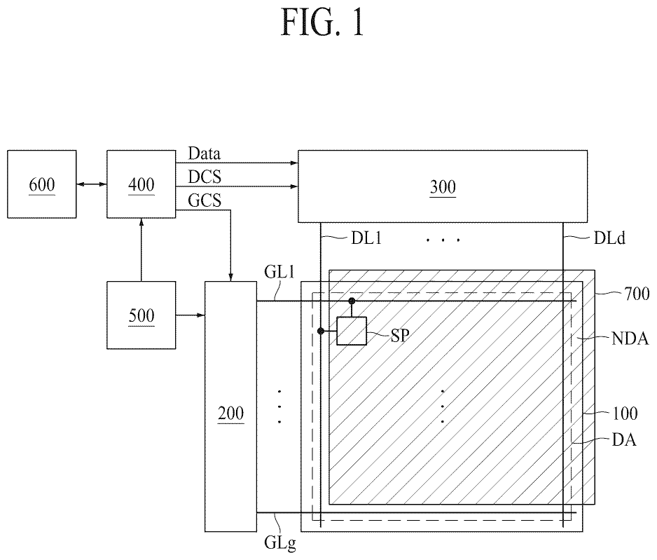

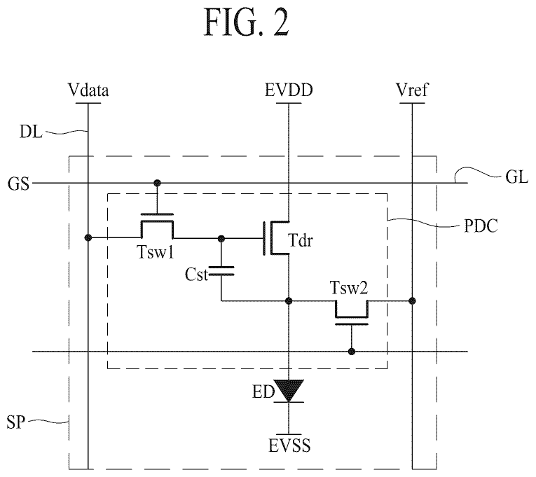

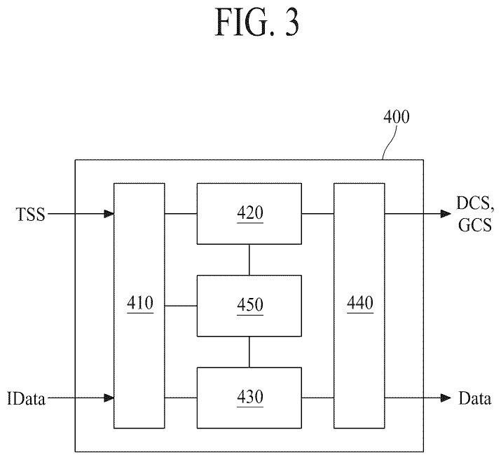

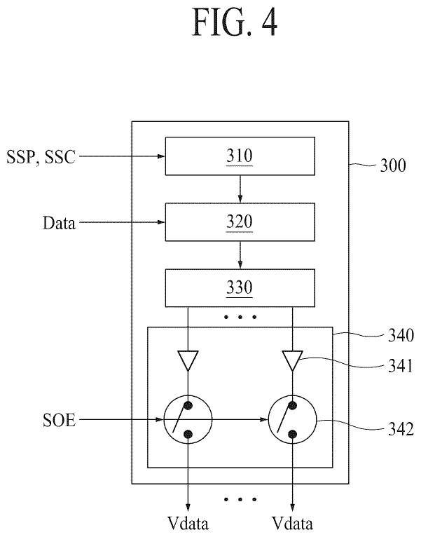

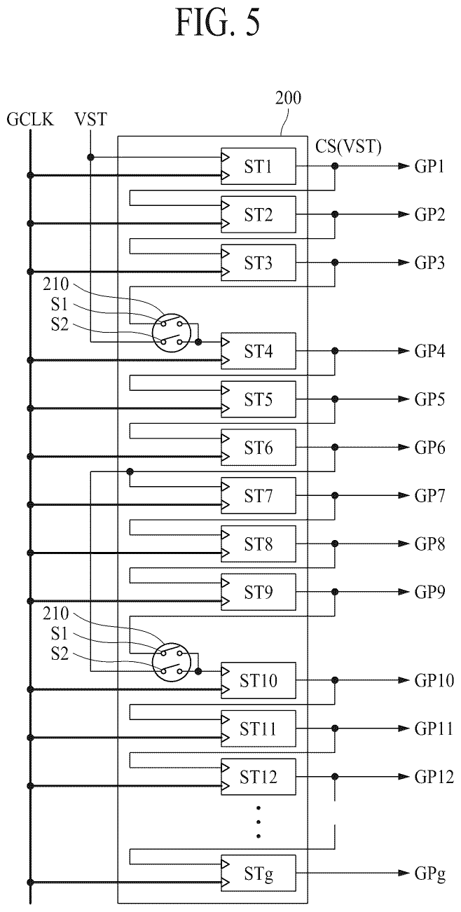

FIG. 1 is an exemplary diagram illustrating a configuration of a stereoscopic image display apparatus according to an embodiment of the present disclosure, FIG. 2 is an exemplary diagram illustrating a structure of a sub-pixel applied to a stereoscopic image display apparatus according to an embodiment of the present disclosure, FIG. 3 is an exemplary diagram illustrating a structure of a control driver applied to a stereoscopic image display apparatus according to an embodiment of the present disclosure, FIG. 4 is an exemplary diagram illustrating a structure of a data driver applied to a stereoscopic image display apparatus according to an embodiment of the present disclosure, and FIG. 5 is an exemplary diagram illustrating a structure of a gate driver applied to a stereoscopic image display apparatus according to an embodiment of the present disclosure.

A stereoscopic image display apparatus according to an embodiment of the present disclosure can be used as various kinds of electronic devices. Electronic devices can be, for example, televisions, monitors, etc.

A stereoscopic image display apparatus according to an embodiment of the present disclosure, as illustrated in FIG. 1, can include a display panel 100 which includes a display area DA displaying an image and a non-display area NDA provided outside the display area DA, a gate driver 200 which supplies gate signals GS to a plurality of gate lines GL1 to GLg provided in the display area DA of the display panel 100, a data driver 300 which supplies data voltages Vdata to a plurality of data lines DL1 to DLd provided in the display area DA of the display panel 100, a control driver 400 which controls driving of the gate driver 200 and the data driver 300, a power supply unit 500 (e.g., a circuit) which supplies power to the control driver 400, the gate driver 200, the data driver 300, and the display panel 100, and a lens unit separating a left-eye image and a right-eye image output from the display panel 100.

First, the display panel 100 can include a display area DA and a non-display area NDA. Gate lines GL1 to GLg, data lines DL1 to DLd, and sub-pixels P can be provided in the display area DA. Accordingly, an image can be displayed in the display area DA. Here, g and d are natural numbers. The non-display area NDA can surround the outer periphery of the display area DA.

The display panel 100 can be a liquid crystal display panel using a liquid crystal, a light emitting display panel using a light emitting device that outputs light by itself, or any one of display panels with various structures currently used.

When the display panel 100 is a light emitting display panel, the sub-pixel SP provided in the display panel 100 can include a pixel driving circuit PDC including a switching transistor Tsw1, a storage capacitor Cst, a driving transistor Tdr, and a sensing transistor Tsw2, and a light emitting device ED connected to the pixel driving circuit PDC, as illustrated in FIG. 2.

However, when the display panel 100 is a light emitting display panel, a structure of the sub-pixel SP applied to a stereoscopic image display apparatus according to an embodiment of the present disclosure is not limited to the structure illustrated in FIG. 2. Accordingly, the structure of the sub-pixel SP can be changed into various structures.

Also, even when the display panel 100 is a liquid crystal display panel, the structure of the sub-pixel SP can be changed into various structures.

Hereinafter, for convenience of description, a stereoscopic image display apparatus according to an embodiment of the present disclosure will be described using a display panel 100 including the sub-pixel SP illustrated in FIG. 2.

The control driver 400 can realign input data signals Ri, Gi, and Bi transmitted from an external system 600 by using a timing synchronization signal TSS transmitted from the external system and can generate a data control signal DCS which is to be supplied to the data driver 300 and a gate control signal GCS which is to be supplied to the gate driver 200.

To this end, as illustrated in FIG. 3, the control driver 400 can include a data aligner 430 (e.g., a circuit) which realigns input data signals IData to generate data signal Data, a control signal generator 420 (e.g., a circuit) which generates the gate control signal GCS and the data control signal DCS by using the timing synchronization signal TSS, an input unit 410 (e.g., a circuit) which transmits the timing synchronization signal TSS transmitted from the external system 600 to the control signal generator 420 and transmits the input data signal IData transmitted from the external system 600 to the data aligner 430, and an output unit 440 (e.g., a circuit) which supplies the data driver 300 with the data signal Data generated by the data aligner 430 and the data control signal DCS generated by the control signal generator 420 and supplies the gate driver 200 with the gate control signal GCS generated by the control signal generator 420.

The control signal generator 420 can generate a power control signal supplied to the power supply unit 500.

The control driver 400 can further include a storage unit (e.g., memory) for storing various information. The storage unit 450 can be included in the control driver 400 as illustrated in FIG. 3, but can be separated from the control driver 400 and provided independently.

The data aligner 430 can generate data signals by aligning the input data signals IData transmitted from the external system 600 based on the structure of the sub-pixels SP during the planar image display period.

Also, the data aligner 430 can generate data signals by aligning the input data signals IData transmitted from the external system 600 based on the structure of sub-pixels SP during a stereoscopic image display period.

The external system 600 can perform a function of driving the control driver 400 and an electronic device.

For example, when the electronic device is a television (TV), the external system 600 can receive various kinds of sound information and image information over a communication network and can transmit the received image information to the control driver 400. For example, the external system 600 can convert the image information into input data signals IData and transmit the input data signals IData to the control driver 400.

Also, when an electronic device is set to display a stereoscopic image, the external system can transmit a setting signal indicating that the current mode is a stereoscopic image mode displaying a stereoscopic image to the control driver 400.

In this case, the control driver 400 can generate data signals Data by aligning the input data signals IData transmitted from the external system 600 to correspond to the stereoscopic image mode and transmit the data signals Data to the data driver 300.

Also, the control driver 400 can generate a gate control signal GCS corresponding to the stereoscopic image mode and transmit the gate control signal GCS to the gate driver 200.

The power supply unit 500 can generate various powers and supply the generated powers to the control driver 400, the gate driver 200, the data driver 300, and the display panel 100.

The data driver 300 can supply data voltages Vdata to the data lines DL1 to DLd.

To this end, the data driver 300, as illustrated in FIG. 4, can include a shift register 310 which outputs a sampling signal, a latch 320 which latches data signals Data received from the control driver 400, a digital-to-analog converter 330 which converts the data signal Data, transmitted from the latch 320, into a data voltage Vdata and outputs the data voltage Vdata, and an output buffer 340 which outputs the data voltage, transmitted from the digital-to-analog converter 330, to the data line DL on the basis of a source output enable signal SOE.

Finally, the gate driver 200 can be directly embedded into the non-display area NDA by using a gate-in panel (GIP) type, or the gate driver 200 can be provided in the display area DA in which light emitting devices ED are provided, or the gate driver 200 can be provided on a chip on film mounted in the non-display area NDA.

The gate driver 200 can supply gate pulses GP1 to GPg to the gate lines GL1 to GLg.

When a gate pulse GP generated by the gate driver 200 is supplied to a gate of the switching transistor Tsw1 included in the sub-pixel P, the switching transistor Tsw1 can be turned on. When the switching transistor Tsw1 is turned on, data voltage Vdata supplied through a data line DL can be supplied to the pixel P.

When a gate-off signal generated by the gate driver 200 is supplied to the switching transistor Tsw1, the switching transistor Tsw1 can be turned off. When the switching transistor Tsw1 is turned off, a data voltage cannot be supplied to the pixel P any longer.

The gate signal GS supplied to the gate line GL can include the gate pulse GP and the gate-off signal.

To supply gate pulses GP1 to GPg to gate lines GL1 to GLg, the gate driver 200, as illustrated in FIG. 5, can include stages ST1 to STg connected to gate lines GL1 to GLg. Each of the stages ST1 to STg can output a gate pulse GP.

Each of the stages ST1 to STg can be connected to one gate line GL, but can be connected to at least two gate lines GL.

In order to generate gate pulses GP1 to GPg, at least one start signal VST and at least one gate clock GCLK which are generated by the control signal generator 420 can be transferred to the gate driver 200. For example, the at least one start signal VST and the at least one gate clock GCLK can be included in the gate control signal GCS.

One of the stages ST1 to STg can be driven by a start signal VST transmitted from the control driver 400 to output a gate pulse GP to a gate line GL. The gate pulse GP can be generated by a gate clock GCLK.

For example, in the gate driver 200 illustrated in FIG. 5, a first stage ST1 can be driven by a start signal VST transmitted from the control driver 400 to output a first gate pulse GP1 to a first gate line GL1.

At least one of signals output from a stage ST where a gate pulse is output can be supplied to another stage ST to drive another stage ST. Accordingly, a gate pulse can be output in another stage ST.

For example, a carry signal CS among signals output from the stage ST in which the gate pulse GP is output can be supplied to the other stage ST. In this case, the carry signal CS can be a start signal of another stage ST. The carry signal CS can be the same signal as the gate pulse GP.

To provide an additional description, among the stages ST1 to STg illustrated in FIG. 5, a carry signal CS output from the first stage ST1 can be supplied to a second stage ST2, and in this case, the carry signal CS output from the first stage ST1 can be a start signal VST of the second stage ST2.

Accordingly, the second stage ST2 can be driven by the carry signal CS output from the first stage ST1, and accordingly, the second stage ST2 can output a second gate pulse GP2.

Also, a third stage ST3 can be driven by a carry signal CS output from the second stage ST2, and accordingly, the third stage ST3 can output a third gate pulse GP3.

By the method described above, the stages ST can be sequentially driven, and accordingly, the gate pulses GP1 to GPg can be sequentially supplied to the gate lines GL.

As illustrated in FIG. 5, the gate driver 200 can include switching units 210 as well as the stages ST1 to STg described above.

A switching unit 210 corresponding to a (6n−2)th stage (n is a natural number of 2 or more) among the switching units 210 can include a first switch S1 connecting the (6n−2)th stage to a (6n−3)th stage and a second switch S2 connecting the (6n−2)th stage to a (6n−6)th stage.

In this case, a switching unit 210 corresponding to a fourth stage ST4 can include a first switch S1 that connects the fourth stage ST4 to the third stage ST3 and a second switch S2 that connects the control driver 400 that supplies the start signal VST to the fourth stage ST4.

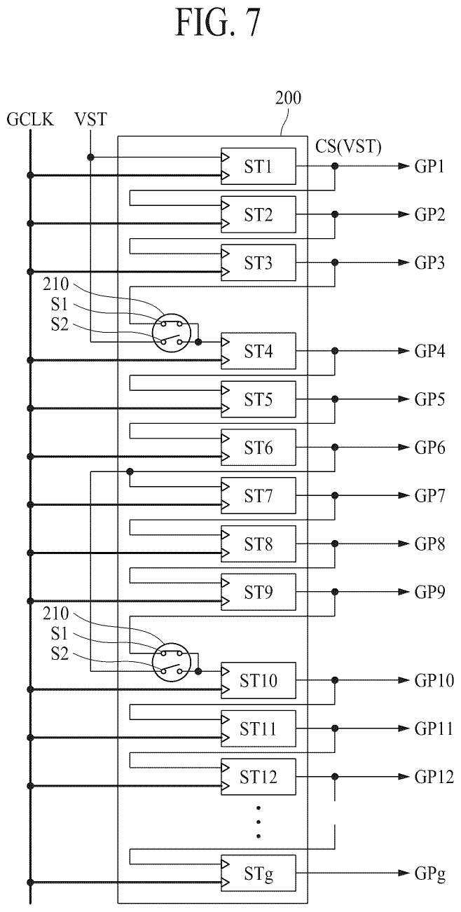

The detailed structure and operation method of the switching unit 210 will be described in detail below with reference to FIGS. 7 to 10.

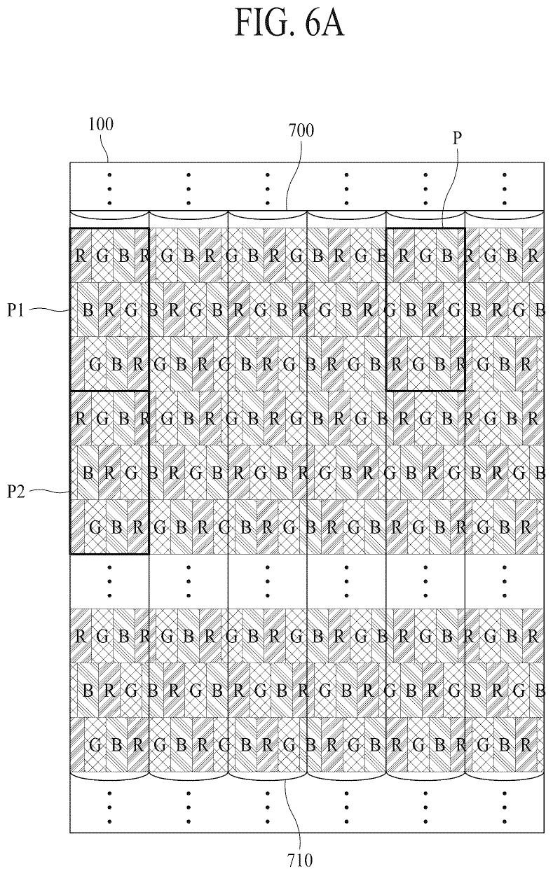

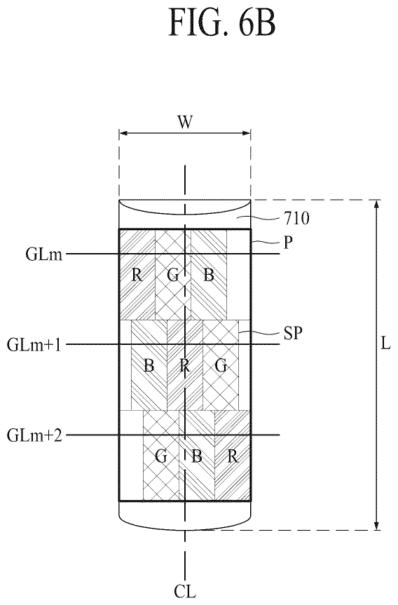

FIG. 6A is an exemplary diagram illustrating a portion of a display panel and a portion of a lens unit applied to a stereoscopic image display apparatus according to an embodiment of the present disclosure, and FIG. 6B is an enlarged exemplary diagram of a pixel and a convex lens illustrated in FIG. 6A according to an embodiment of the present disclosure. In the following descriptions, details that are the same as or similar to details described with reference to FIGS. 1 to 5 are omitted or briefly described.

First, the lens unit 700 can perform a function of separating a left-eye image and a right-eye image output from the display panel 100. To this end, the lens unit 700 can include convex lenses.

As the left-eye image is recognized in the user's left eye by the lens unit 700 and the right-eye image is recognized in the user's right eye, the user can recognize a stereoscopic image.

A stereoscopic image display apparatus according to an embodiment of the present disclosure can include a display panel 100 provided with gate lines GL1 to GLg and displaying a planar image or a stereoscopic image, a lens unit 700 for separating a left-eye image and a right-eye image output from the display panel 100, and a gate driver 200 for supplying gate pulses GP1 to GPg to gate lines GL1 to GLg.

In this case, during the stereoscopic image display period in which the stereoscopic image is displayed on the display panel 100, the gate driver 200 can simultaneously supply a gate pulse GP to two gate lines spaced apart from each other with two gate lines GL interposed therebetween.

For example, a stereoscopic image display apparatus according to an embodiment of the present disclosure can display a two-dimensional (2D) image (hereinafter simply referred to as a planar image) or a three-dimensional (3D) image (hereinafter simply referred to as a stereoscopic image) based on a setting signal transmitted from the external system 600.

To provide an additional description, when a stereoscopic image display apparatus according to an embodiment of the present disclosure is a notebook computer, the notebook computer can be driven in a planar image mode displaying a planar image.

When a user executes a program that supports stereoscopic images, such as a game, on the notebook computer, the external system 600 can transmit a setting signal indicating that the current mode has been changed to a stereoscopic image mode displaying stereoscopic images to the control driver 400.

Also, when the user who runs the game enters a menu that changes the notebook computer's mode from a planar image mode to a stereoscopic image mode through an input unit of the notebook computer, the external system 600 can transmit a setting signal indicating that the current mode has been changed to a stereoscopic image mode that displays stereoscopic images from the planar image mode to the control driver 400.

That is, the external system of the stereoscopic image display apparatus can start the stereoscopic image mode based on the request of the user or automatically start the stereoscopic image mode by using information from the program performed on the stereoscopic image display apparatus.

In this case, the control driver 400 can generate data signals Data by rearranging the input data signals IData transmitted from the external system 600 to correspond to the stereoscopic image mode and transmit the data signals Data to the data driver 300.

Also, the control driver 400 can generate a gate control signal GCS corresponding to the stereoscopic image mode and transmit the gate control signal GCS to the gate driver 200.

In the following description, a period in which a planar image is displayed is referred to as a planar image display period, and a period in which a stereoscopic image is displayed is referred to as a stereoscopic image display period.

Next, as illustrated in FIGS. 6A and 6B, the lens unit 700 can be provided on the top surface of the display panel 100 including the sub-pixels SP, and the lens unit 700 can include convex lenses 710. Accordingly, light output from the display panel 100 can be output to the outside of the display apparatus through the lens unit 700.

In particular, the lens unit 700 can be provided on the top surface of the display panel 100 to cover all sub-pixels SP provided in the display panel 100. However, in order to clarify the arrangement structure of the display panel 100 and the lens unit 700, the upper and lower ends of the lens unit 700 are omitted in FIG. 6A. Also, in FIG. 6B, one convex lens 710 constituting the lens unit 700 and one pixel P overlapping the convex lens 710 are illustrated. For example, pixels P can also exist at the upper and lower ends of the convex lens 710 illustrated in FIG. 6B. However, for convenience of description, one pixel P overlapping the convex lens 710 is illustrated in FIG. 6B.

Next, in order to display a planar image or a stereoscopic image, sub-pixels SP are provided in the display panel 100, and among the sub-pixels SP, nine sub-pixels SP arranged in a 3×3 form can be pixels P that display one sub-image, as illustrated in FIGS. 6A and 6B.

That is, the pixel P can include nine sub-pixels SP, nine sub-pixels SP can be arranged in a 3×3 form, and one sub-image can be displayed by nine sub-pixels SP.

To provide an additional description, the pixel P can include three first sub-pixels, three second sub-pixels, and three third sub-pixels.

That is, the nine sub-pixels SP can include three first sub-pixels, three second sub-pixels, and three third sub-pixels.

In this case, colors of the first sub-pixel, the second sub-pixel, and the third sub-pixel can be variously changed.

For example, each of the three first sub-pixels can be a red sub-pixel, each of the three second sub-pixels can be a green sub-pixel, and each of the three third sub-pixels can be a blue sub-pixel.

Hereinafter, for convenience of description, a stereoscopic image display apparatus in which the first sub-pixel is a red sub-pixel, the second sub-pixel is a green sub-pixel, and the third sub-pixel is a blue sub-pixel is described as an example of a stereoscopic image display apparatus according to an embodiment of the present disclosure.

Accordingly, in the following description, a reference numeral R can be given to each of the first sub-pixels, a reference numeral G can be given to each of the second sub-pixels, and a reference numeral B can be given to each of the third sub-pixels.

In this case, the three first sub-pixels R can be connected to different gate lines.

For example, when the three first sub-pixels R include the 1ath sub-pixel, the 1bth sub-pixel, and the 1cth sub-pixel, as illustrated in FIG. 6b, the 1ath sub-pixel can be connected to a mth (m is a natural number) gate line GLm, a 1bth sub-pixel can be connected to a (m+1)th gate line GLm+1, and a 1cth sub-pixel can be connected to a (m+2)th gate line GLm+2. In the following description, for convenience of description, each of the 1ath sub-pixel, the 1bth sub-pixel, and the 1cth sub-pixel can also be given a reference numeral R.

Also, when the three second sub-pixels G include a 2ath sub-pixel, a 2bth sub-pixel, and a 2cth sub-pixel, as illustrated in FIG. 6B, the 2ath sub-pixel can be connected to the mth gate line GLm, the 2bth sub-pixel can be connected to the (m+1)th gate line GLm+1, and the 2cth sub-pixel can be connected to the (m+2)th gate line GLm+2. In the following description, for convenience of description, each of the 2ath sub-pixels, the 2bth sub-pixel, and the 2cth sub-pixel can also be given a reference numeral G.

Moreover, when the three third sub-pixels B include a 3ath sub-pixel, a 3bth sub-pixel, and a 3cth sub-pixel, as illustrated in FIG. 6B, the 3ath sub-pixel can be connected to the mth gate line GLm, the 3bth sub-pixel can be connected to the (m+1)th gate line GLm+1, and the 3cth sub-pixel can be connected to the (m+2)th gate line GLm+2. In the following description, for convenience of description, each of the 3ath sub-pixels, the 3bth sub-pixel, and the 3cth sub-pixel can also be given a reference numeral B.

In this case, the nine sub-pixels SP can be provided at positions corresponding to the convex lens 710 constituting the lens unit 700.

For example, as illustrated in FIG. 6B, nine sub-pixels SP arranged in a 3×3 form can overlap one convex lens 710.

In particular, a convex surface of the convex lens 710 can be disposed to face a direction opposite to that of the display panel 100. Therefore, the plane of the convex lens 710 can be in contact with the top surface of the display panel 100.

Accordingly, light output from the display panel 100 can be transmitted to the convex surface of the convex lens 710 through the plane of the convex lens 710 and can be output to the outside of the convex lens 710 through the convex surface of the convex lens 710.

The convex lens 710 can extend along a first direction different from a direction in which the gate lines GLs extend.

For example, the convex lens 710 can have a shape of a half cylinder extending along the first direction of the display panel 100, as illustrated in FIGS. 6A and 6B. Here, the first direction can mean a direction different from a direction in which the gate line GL extends, for example, a direction perpendicular to the direction in which the gate line GL extends. In this case, the direction in which the gate line GL extends can be the second direction.

As described above, the nine sub-pixels SP can overlap the convex lens 710.

To this end, the width W of the convex lens 710 can be greater than or equal to the widths of the three sub-pixels SP. Also, the length L of the convex lens can be greater than the length of the three sub-pixels SP.

Next, among the first sub-pixels R, a 1ath sub-pixel can be provided on a first side of the convex lens 710, a 1cth sub-pixel can be provided on a second side opposite to the first side with respect to a longitudinal direction of the convex lens 710, and a 1bth sub-pixel can be provided between the 1ath sub-pixel and the 1cth sub-pixel.

For example, in FIG. 6B, the 1ath sub-pixel R connected to the mth gate line GLm can be provided on the left side of the convex lens 710, the 1cth sub-pixel R connected to the (m+2)th gate line GLm+2 can be provided on the right side of the convex lens 710, and the 1bth sub-pixel R connected to the (m+1)th gate line GLm+1 can be provided between the 1ath sub-pixel R and the 1cth sub-pixel R.

For example, the 1bth sub-pixel R connected to the (m+1)th gate line GLm+1 can overlap the center line CL provided at the center portion of the convex lens 710 along the longitudinal direction of the convex lens 710, as illustrated in FIG. 6B. The center line CL is a virtual line illustrated for convenience of description.

In this case, for example, light output from sub-pixels SP provided on the left side of the center line CL of the convex lens 710 can be input to the user's left eye, and light output from sub-pixels SP provided on the right side of the center line CL can be input to the user's right eye.

Accordingly, the user can recognize the stereoscopic image.

Next, in a planar image display period in which a planar image is displayed on the display panel 100, a planar sub-image can be output from a pixel P. The planar sub-images output from all the pixels P provided in the display panel 100 can form a single planar image.

During the planar image display period, in two pixels P adjacent to each other along the first direction different from the direction in which the gate lines GL extend, the same planar sub-images can be output or different planar sub-images can be output.

For example, during the planar image display period, in the first pixel P1 and the second pixel P2 illustrated in FIG. 6A, the same planar sub-images can be output or different planar sub-images can be output.

However, during the stereoscopic image display period in which the stereoscopic image is displayed on the display panel 100, the same stereoscopic sub-images are output in two pixels P adjacent to each other along the first direction different from the direction in which the gate lines GLs are extended.

For example, during the stereoscopic image display period, the same stereoscopic sub-images are output in the first pixel P1 and the second pixel P2 illustrated in FIG. 6A.

To provide an additional description, in the planar image display period, two pixels P adjacent along the first direction can independently display planar sub-images.

However, because the same stereoscopic sub-images are output from the two pixels P adjacent along the first direction in the stereoscopic image display period, the two pixels P adjacent along the first direction can be recognized as one pixel P.

Therefore, the resolution of the stereoscopic image can be ½ of the resolution of the planar image.

Next, in the planar image display period, in order to output one planar sub-image from the pixel P, the three first sub-pixels R provided in the pixel P are supplied with first data voltages with the same level, the three second sub-pixels G provided in the pixel P are supplied with second data voltages with the same level, and the three third sub-pixels B provided in the pixel P are supplied with third data voltages with the same level.

Therefore, during the planar image display period, the three first sub-pixels R provided in the pixel P output lights of the same luminance, the three second sub-pixels G provided in the pixel P output lights of the same luminance, and the three third sub-pixels B provided in the pixel P output lights of the same luminance.

To provide an additional description, during the planar image display period, the three first sub-pixels R provided in the pixel P can perform the function of one first sub-pixel R, the three second sub-pixels G provided in the pixel P can perform the function of one second sub-pixel G, and the three third sub-pixels B provided in the pixel P can perform the function of one third sub-pixel B.

Accordingly, during the planar image display period, the pixel P can output one planar sub-image.

In this case, light of the same luminance can be output from the first sub-pixels R provided on the left and right sides of the convex lens 710, light of the same luminance can be output from the second sub-pixels G provided on the left and right sides of the convex lens 710, and light of the same luminance can be output from the third sub-pixels B provided on the left and right sides of the convex lens 710.

Accordingly, the same planar sub-image can be recognized in the left and right eyes of the user. Therefore, during the planar image display period, the user can recognize the planar image.

However, in order to output one stereoscopic sub-image from the pixel P during the stereoscopic image display period, first data voltages with different levels are supplied to the three first sub-pixels R provided in the pixel P, second data voltages with different levels are supplied to the three second sub-pixels G provided in the pixel P, and third data voltages with different levels are supplied to the three third sub-pixels B provided in the pixel P.

Therefore, during the stereoscopic image display period, the three first sub-pixels R provided in the pixel P output light of different luminance, the three second sub-pixels G provided in the pixel P output light of different luminance, and the three third sub-pixels B provided in the pixel P output light of different luminance.

To provide an additional description, during the stereoscopic image display period, each of the three first sub-pixels R provided in the pixel P can be independently driven, each of the three second sub-pixels G provided in the pixel P can be independently driven, and each of the three third sub-pixels B provided in the pixel P can be independently driven.

Data signals corresponding to data voltages supplied to nine sub-pixels SP provided in the pixel P can be generated by the control driver 400.

In this case, the control driver 400 can generate data signals by using input data signals IData transmitted from the external system 600 for outputting a stereoscopic image or can rearrange input data signals IData transmitted from the external system 600 in order to output a stereoscopic image to generate data signals Data.

Accordingly, during the stereoscopic image display period, the pixel P can output one stereoscopic sub-image.

To provide an additional description, during the stereoscopic image display period, the luminance of light output from the first sub-pixel R on the left side of the convex lens 710 and the luminance of light output from the first sub-pixel R on the right side are different, the luminance of light output from the second sub-pixel G on the left side of the convex lens 710 and the luminance of light output from the second sub-pixel G on the right side are different, and the luminance of light output from the third sub-pixel B on the right side are different. Therefore, one stereoscopic sub-image can be divided into a left-eye stereoscopic sub-image and a right-eye stereoscopic sub-image through the convex lens 710.

Accordingly, a left-eye stereoscopic sub-image can be recognized by the user's left eye and a right-eye stereoscopic sub-image can be recognized by the user's right eye. Therefore, during the stereoscopic image display period, the user can recognize the stereoscopic image.

To provide an additional description, in the stereoscopic image display period, the stereoscopic sub-image output from the pixel P can be divided into a left-eye stereoscopic sub-image and a right-eye stereoscopic sub-image and can be input to the left and right eyes of the user. Accordingly, in the stereoscopic image display period, the user can recognize the stereoscopic image.

Finally, first to third gate lines are connected to a first pixel among the pixels P provided in the display panel 100, and fourth to sixth gate lines are connected to a second pixel adjacent to the first pixel along the first direction different from the direction in which the gate lines GL extend.

For example, as illustrated in FIG. 6B, three gate lines GLm, GLm+1, and GLm+2 can be connected to each of the pixels P.

Accordingly, three gate lines GLs can be connected to the first pixel P1 illustrated in FIG. 6A, and three gate lines GLs can be also connected to the second pixel P2 adjacent to the first pixel P1 along the first direction.

In this case, during the stereoscopic image display period, the gate driver 200 can supply gate pulses to the first and fourth gate lines at the same time, supply gate pulses to the second and fifth gate lines at the same time, and supply gate pulses to the third and sixth gate lines at the same time.

Accordingly, for example, the same data voltages can be supplied to the first sub-pixel R of the first pixel P1 connected to the first gate line and the first sub-pixel R of the second pixel P2 connected to the fourth gate line, the same data voltages can be supplied to the second sub-pixel G of the first pixel P1 connected to the first gate line and the second sub-pixel G of the second pixel P2 connected to the fourth gate line, and the same data voltages can be supplied to the third sub-pixel B of the first pixel P1 connected to the first gate line and the third sub-pixel B of the second pixel P2 connected to the fourth gate line.

Also, by the above method, the same data voltages can be supplied to sub-pixels SP connected to the second gate line and sub-pixels SP connected to the fifth gate line, and the same data voltages can be supplied to sub-pixels SP connected to the third gate line and sub-pixels SP connected to the sixth gate line.

Accordingly, the same stereoscopic sub-images can be output from the first pixel P1 and the second pixel P2 illustrated in FIG. 6A.

However, during the planar image display period, the gate driver 200 can sequentially supply gate pulses to the first to sixth gate lines, and accordingly, different planar sub-images can be output from the first pixel P1 and the second pixel P2.

Therefore, the resolution of the display panel 100 in the stereoscopic image display period can be ½ of the resolution of the display panel 100 in the planar image display period.

However, the number of times a stereoscopic image is displayed in one second can be twice the number of times a planar image is displayed in one second.

For example, if the driving frequency in the planar image display period is 240 Hz, the driving frequency in the stereoscopic image display period can be 480 Hz.

Therefore, although the resolution in the stereoscopic image display period decreases, the driving frequency in the stereoscopic image display period increases, and thus the quality of stereoscopic images can be the same as or similar to that of planar images.

Hereinafter, the structure and operation method of the gate driver 200 will be described with reference to FIGS. 7 to 10 in order to simultaneously supply gate pulses to the first and fourth gate lines, simultaneously supply gate pulses to the second and fifth gate lines, and simultaneously supply gate pulses to the third and sixth gate lines during the stereoscopic image display period.

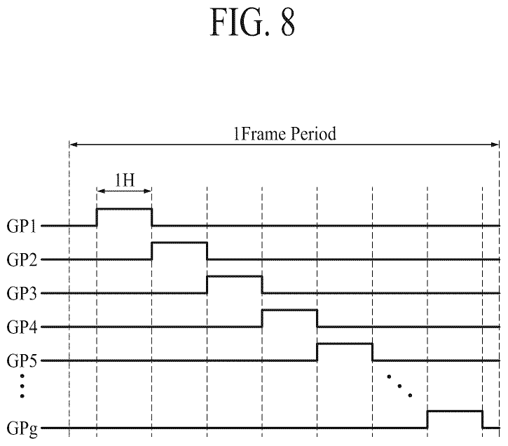

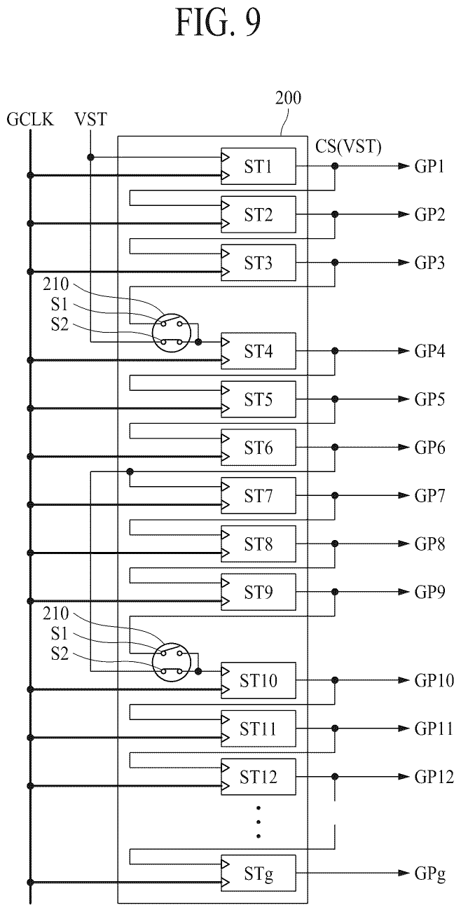

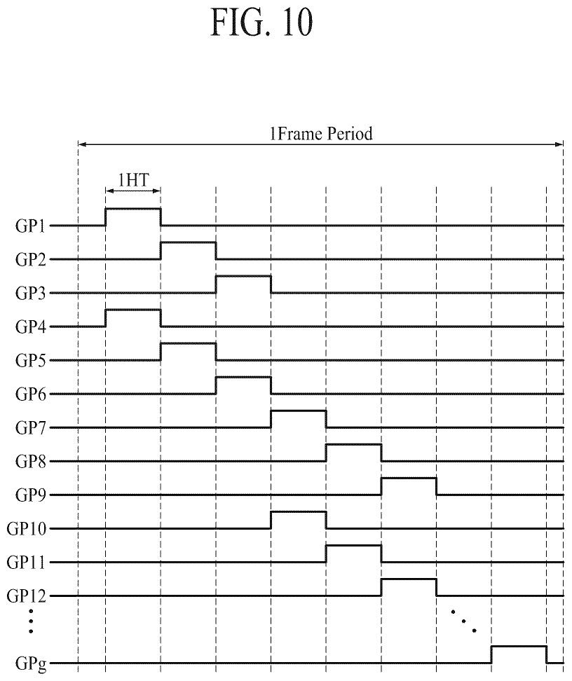

FIG. 7 is another exemplary diagram illustrating a structure of a gate driver applied to a stereoscopic image display apparatus according to an embodiment of the present disclosure, FIG. 8 is an exemplary diagram illustrating gate pulses output by the gate driver illustrated in FIG. 7, FIG. 9 is another exemplary diagram illustrating a structure of a gate driver applied to a stereoscopic image display apparatus according to an embodiment of the present disclosure, and FIG. 10 is an exemplary diagram illustrating gate pulses output by the gate driver illustrated in FIG. 9. In the following descriptions, details that are the same as or similar to details described with reference to FIGS. 1 to 6B are omitted or briefly described.

First, the gate driver 200 can include stages ST1 to STg and switching units 210, as illustrated in FIGS. 5, 7, and 9.

Among the switching units 210, a switching unit 210 corresponding to a (6n-2)th stage (n is a natural number of 2 or more) can include a first switch S1 connecting the (6n-2)th stage to a (6n-3)th stage and a second switch S2 connecting the (6n-2)th stage to a (6n-6)th stage.

For example, when n is 2, as illustrated in FIG. 7, a switching unit 210 corresponding to a tenth stage ST10 can include a first switch S1 connecting the tenth stage ST10 to a ninth stage ST9 and a second switch S2 connecting the tenth stage ST10 to the sixth stage ST6.

In this case, a switching unit 210 corresponding to a fourth stage ST4 can include a first switch S1 that connects the fourth stage ST4 to a third stage ST3 and a second switch S2 that connects the control driver 400 that supplies a start signal VST to the fourth stage ST4.

Next, among the switching units 210, a switching unit 210 corresponding to a (6n−2)th stage (n is a natural number of 2 or more) can connect the (6n−2) stage to a (6n−3)th stage or the (6n−2)th stage to a (6n−6)th stage.

For example, when n is 2 and the first switch S1 is turned on and the second switch S2 is turned off by a control signal transmitted from the control driver 400, a switching unit 210 corresponding to the tenth stage ST10 can connect the tenth stage ST10 to the ninth stage ST9.

Also, when n is 2 and the first switch S1 is turned off and the second switch S2 is turned on by a control signal transmitted from the control driver 400, the switching unit 210 corresponding to the tenth stage ST10 can connect the tenth stage ST10 to the sixth stage ST6.

In this case, when the first switch S1 is turned on and the second switch S2 is turned off by a control signal transmitted from the control driver 400, the switching unit 210 corresponding to the fourth stage ST4 can connect the fourth stage ST4 to the third stage ST3.

Also, when the first switch S1 is turned off and the second switch S2 is turned on by a control signal transmitted from the control driver 400, the switching unit 210 corresponding to the fourth stage ST4 can connect the control driver 400 that supplies a start signal VST to the fourth stage ST4.

Next, the switching unit 210 corresponding to the (6n−2)th stage can supply a carry signal CS output from a (6n−3)th stage to the (6n−2) stage or the carry signal CS output from the (6n−6)th stage to the (6n−2)th stage.

For example, when n is 2 and the first switch S1 is turned on and the second switch S2 is turned off by a control signal transmitted from the control driver 400, the switching unit 210 corresponding to the tenth stage ST10 can supply a carry signal CS output from the ninth stage ST9 to the tenth stage ST10.

Also, when n is 2 and the first switch S1 is turned off and the second switch S2 is turned on by a control signal transmitted from the control driver 400, the switching unit 210 corresponding to the tenth stage ST10 can supply a carry signal CS output from the sixth stage ST6 to the tenth stage ST10.

In this case, when the first switch S1 is turned on and the second switch S2 is turned off by a control signal transmitted from the control driver 400, the switching unit corresponding to the fourth stage ST4 can supply a carry signal CS output from the third stage ST3 to the fourth stage ST4.

Also, when the first switch S1 is turned off and the second switch S2 is turned on by a control signal transmitted from the control driver 400, the switching unit corresponding to the fourth stage ST4 can supply a start signal VST, which is supplied from the control driver 400 to the first stage ST1, to the fourth stage ST4.

Next, a switching unit 210 corresponding to a (6n−2)th stage can connect the (6n−2)th stage to a (6n−3)th stage during the planar image display period in which a planar image is displayed on the display panel 100.

For example, as illustrated in FIG. 7, when n is 2 and the first switch S1 is turned on and the second switch S2 is turned off by a control signal transmitted from the control driver 400, the switching unit 210 corresponding to the tenth stage ST10 can connect the tenth stage ST10 to the ninth stage ST9.

In this case, the switching unit 210 corresponding to the fourth stage ST can connect the fourth stage ST4 to the third stage ST3 during the planar image display period.

Also, each of the stages ST can be connected to a front stage by the remaining switching units 210.

For example, a sixteenth stage (when n is 3) can be connected to a fifteenth stage, and a twenty-second stage (when n is 4) can be connected to a twenty-first stage.

Also, each of the remaining stages ST can also be connected to a front stage.

For example, the second stage ST2 can be connected to the first stage ST1, the third stage ST3 can be connected to the second stage ST2, and the fifth stage ST5 can be connected to the fourth stage ST4.

Therefore, the remaining stages except for the first stage ST1 can be connected to a front stage. The first stage ST1 can be driven by receiving a start signal VST from the control driver 400.

Accordingly, as illustrated in FIGS. 7 and 8, when the first gate pulse GP1 is output from the first stage ST1 by the start signal VST transmitted from the control driver 400, the second stage ST2 to the gth stage STg can be sequentially driven to sequentially output the second gate pulse GP2 to the gth gate pulse GPg.

The first gate pulse GP1 to the gth gate pulse GPg can be output to the first gate line GL1 to the gth gate line GLg during the first frame period.

When the pulse width of the gate pulse GP is 1HT, data voltages Vdata can be output to the data lines DL1 to DLd during 1HT. Accordingly, light can be output from each of the sub-pixels SP connected to a gate line GL to which a gate pulse GP is supplied.

Accordingly, during one frame period, a planar sub-image can be displayed in each of all pixels P provided on the display panel 100, and thus one planar image can be displayed through all pixels P.

Finally, a switching unit 210 corresponding to the (6n−2)th stage can connect the (6n−2)th stage to the (6n−6)th stage during the stereoscopic image display period in which the stereoscopic image is displayed on the display panel 100.

For example, in the stereoscopic image display period, as illustrated in FIG. 9, when n is 2 and the first switch S1 is turned off and the second switch S2 is turned on by a control signal transmitted from the control driver 400, the switching unit 210 corresponding to the tenth stage ST10 can connect the tenth stage ST10 to the sixth stage ST6.

In this case, the switching unit 210 corresponding to the fourth stage ST can connect the control driver 400, which supplies a start signal VST, to the fourth stage ST4 during the stereoscopic image display period.

Also, each of the stages corresponding to the remaining switching units 210 can be connected to a stage spaced apart from each other with three stages interposed therebetween.

For example, the sixteenth stage (when n is 3) can be connected to the twelfth stage ST12, and the twenty-second stage (when n is 4) can be connected to the eighteenth stage.

In this case, each of the remaining stages ST can be connected to a front stage.

For example, the second stage ST2 can be connected to the first stage ST1, the third stage ST3 can be connected to the second stage ST2, and the fifth stage ST5 can be connected to the fourth stage ST4.

The first stage ST1 can be connected to the control driver 400 and can be driven by receiving a start signal VST from the control driver 400.

Accordingly, as illustrated in FIGS. 9 and 10, when a first gate pulse GP1 is output from the first stage ST1 by the start signal VST transmitted from the control driver 400, a fourth gate pulse GP4 can be output from the fourth stage ST1 by the start signal VST transmitted from the control driver 400. Thereafter, when a second gate pulse GP2 is output from the second stage ST2 by a carry signal CS output from the first stage ST1, a fifth gate pulse GP5 can be output from the fifth stage ST5 by a carry signal CS output from the fourth stage ST4. Thereafter, when a third gate pulse GP3 is output from the third stage ST3 by a carry signal CS output from the second stage ST2, a sixth gate pulse GP6 can be output from the sixth stage ST6 by a carry signal CS output from the fifth stage ST5.

Moreover, the same method as the above-described process can be performed in the seventh to gth stages ST7 to STg.

Therefore, as illustrated in FIG. 10, when the seventh to ninth gate pulses GP7 to GP9 are output to the seventh to ninth gate lines, the tenth to twelfth gate pulses GP10 to GP12 can be output to the tenth to twelfth gate lines at the same timing as the seventh to ninth gate pulses GP7 to GP9.

Therefore, during one frame period, the same stereoscopic sub-image can be displayed in two pixels P adjacent to each other in the first direction, such as the first pixel P1 and the second pixel P2 illustrated in FIG. 6A, and thus one stereoscopic image can be displayed through all pixels P.

According to a stereoscopic image display apparatus according to an embodiment of the present disclosure, although the resolution decreases in the stereoscopic image display period, the quality of stereoscopic image can be the same as or similar to that of planar image because the driving frequency increases in the stereoscopic image display period.

Also, a stereoscopic image display apparatus, which doubles the display speed of stereoscopic images and reduces the resolution of stereoscopic images displayed during the stereoscopic image display period to ½, was described above.

However, even when the planar image is output during the planar image display period, the stereoscopic image display apparatus according to an embodiment of the present disclosure can improve the display speed (or driving frequency or refresh rate) of a planar image by reducing the resolution of the planar image, based on a user's request or inherent function of the stereoscopic image display apparatus

For example, not only during the stereoscopic image display period but also during the planar image display period, the gate driver 200 can be driven in the same method as described with reference to FIGS. 9 and 10 under the control of the control driver 400. Therefore, in the stereoscopic image display apparatus, a planar image with a resolution reduced by ½ can be displayed by a doubled driving frequency.

That is, according to a stereoscopic image display apparatus according to an embodiment of the present disclosure, a planar image or a stereoscopic image can be displayed at a high refresh rate (or scanning rate) while the vertical resolution of the planar image and stereoscopic image is reduced.

The features of the light emitting display apparatus according to an embodiment of the present disclosure are briefly summarized as follows.

A stereoscopic image display apparatus according to an embodiment of the present disclosure comprises a display panel including gate lines, on which a planar image or a stereoscopic image is displayed, a lens unit separating a left-eye image and a right-eye image output from the display panel, and a gate driver supplying gate pulses to the gate lines, wherein during a stereoscopic image display period in which a stereoscopic image is displayed on the display panel, the gate driver simultaneously supplies gate pulses to two gate lines that are spaced apart with two gate lines interposed therebetween.

Sub-pixels are provided in the display panel, and nine subpixels arranged in a 3×3 form among the sub-pixels are a pixel that display one sub-image.

The nine sub-pixels are provided at positions corresponding to a convex lens constituting the lens unit.

The nine sub-pixels include three first sub-pixels, three second sub-pixels, and three third sub-pixels, and the convex lens extends along a first direction different from a direction in which the gate lines extend.

Among the first sub-pixels, a 1ath subpixel is provided on the first side of the convex lens, a 1cth subpixel is provided on the second side opposite to the first side with respect to a longitudinal direction of the convex lens, and a 1bth subpixel is provided between the 1ath subpixel and the 1bth subpixel.

The pixel includes three first sub-pixels, three second sub-pixels, and three third sub-pixels, and the three first sub-pixels are connected to different gate lines.

During a planar image display period in which a planar image is displayed on the display panel, a planar sub-image is output from the pixel, and during the stereoscopic image display period, the same stereoscopic sub-images are output from two pixels adjacent along a first direction different from a direction in which the gate lines extend.

During a planar image display period in which a planar image is displayed on the display panel, first data voltages having the same level are supplied to three first sub-pixels provided in the pixel, second data voltages having the same level are supplied to three second sub-pixels provided in the pixel, and third data voltages having the same level are supplied to three third sub-pixels provided in the pixel.

During the stereoscopic image display period, first data voltages having different levels are supplied to three first sub-pixels provided in the pixel, second data voltages having different levels are supplied to three second sub-pixels provided in the pixel, and third data voltages having different levels are supplied to three third sub-pixels provided in the pixel.

A first gate line to a third gate line are connected to a first pixel among the pixels provided in the display panel, and a fourth gate line to a sixth gate line are connected to a second pixel adjacent to the first pixel along a first direction different from a direction in which the gate lines extend.

During the stereoscopic image display period, the gate driver simultaneously supplies gate pulses to the first gate line and the fourth gate line, the gate driver simultaneously supplies gate pulses to the second gate line and the fifth gate line, and the gate driver simultaneously supplies gate pulses to the third gate line and the sixth gate line.

The gate driver comprises stages outputting gate pulses and switching units, and among the switching units, a switching unit corresponding to a (6n−2)th stage (n is a natural number of 2 or more) comprises a first switch connecting the (6n−2)th stage to a (6n−3)th stage and a second switch connecting the (6n−2)th stage to a (6n−6)th stage.

Among the switching units, a switching unit corresponding to a fourth stage comprises a first switch connecting the fourth stage to a third stage and a second switch connecting a control driver, which supplies a start signal, to the fourth stage.

The gate driver comprises stages outputting gate pulses and switching units, and among the switching units, a switching unit corresponding to a (6n−2)th stage (n is a natural number of 2 or more) connects the (6n−2)th stage to a (6n−3)th stage or a (6n−6)th stage.

Among the switching units, a switching unit corresponding to a fourth stage connects the fourth stage to a third stage or connects a control driver, which supplies a start signal, to the fourth stage.

The switching unit corresponding to the (6n−2) stage supplies a carry signal output from the (6n−3)th stage to the (6n−2)th stage or supplies a carry signal output from the (6n−6)th stage to the (6n−2)th stage.

Among the switching units, a switching unit corresponding to a fourth stage supplies a carry signal output from a third stage to the fourth stage or supplies a start signal, which is supplied from a control driver to the first stage, to the fourth stage.

A switching unit corresponding to the (6n−2) stage connects the (6n−2)th stage to the (6n−3)th stage during a planar image display period in which a planar image is displayed in the display panel, and connects the (6n−2)th stage to the (6n−6)th stage during the stereoscopic image display period.

Among the switching units, a switching unit corresponding to a fourth stage connects the fourth stage to a third stage during a planar image display period in which a planar image is displayed in the display panel, and connects the fourth stage to a control driver, which supplies a start signal, during the stereoscopic image display period.

According to a stereoscopic image display apparatus according to an embodiment of the present disclosure, planar images and stereoscopic images can be displayed, and a display speed of a stereoscopic image during the stereoscopic image display period can be higher than a display speed of a planar image during the planar image display period.

Therefore, even when the resolution of the stereoscopic image is smaller than the resolution of the planar image, the quality of the stereoscopic image can be maintained to be the same as or similar to the quality of the planar image. Accordingly, the quality of the stereoscopic image display apparatus can be improved.

In particular, when one sub-image is displayed in a pixel connected to three data lines, a stereoscopic image can be displayed normally because a gate pulse can be simultaneously supplied to two gate lines spaced apart from each other with two gate lines therebetween.

Also, even when a planar image is output, a stereoscopic image display apparatus according to an embodiment of the present disclosure can improve the display speed of a planar image based on a user's request or an inherent function of the stereoscopic image display apparatus, while reducing the resolution of the planar image. Accordingly, a clearer planar image can be provided to the user.

That is, according to a stereoscopic image display apparatus according to an embodiment of the present disclosure, a planar image or a stereoscopic image can be displayed at a high refresh rate (or scanning rate) while the vertical resolution of the planar image and stereoscopic image is reduced.

The stereoscopic image display apparatus according to the present disclosure can be applied to all electronic devices including a display panel. For example, the stereoscopic image display apparatus according to the present disclosure can be applied to a virtual reality (VR) device, an augmented reality (AR) device, a mobile device, a video phone, a smart watch, a watch phone, or a wearable device, foldable device, rollable device, bendable device, flexible device, curved device, electronic notebook, e-book, PMP (portable multimedia player), PDA (personal digital assistant), MP3 player, mobile medical device, desktop PC, laptop PC, netbook computer, workstation, navigation, car navigation, vehicle display apparatus, televisions, wall paper display apparatus, signage devices, game devices, laptops, monitors, cameras, camcorders, and home appliances.

The above-described feature, structure, and effect of the present disclosure are included in at least one embodiment of the present disclosure, but are not limited to only one embodiment. Furthermore, the feature, structure, and effect described in at least one embodiment of the present disclosure can be implemented through combination or modification of other embodiments by those skilled in the art. Therefore, content associated with the combination and modification should be construed as being within the scope of the present disclosure.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the present disclosure.

What is claimed is:

1. A stereoscopic image display apparatus comprising:
a display panel on which a planar image or a stereoscopic image is displayed, the display panel including gate lines;
a lens unit separating a left-eye image and a right-eye image output from the display panel; and
a gate driver supplying gate pulses to the gate lines,
wherein during a stereoscopic image display period in which a stereoscopic image is displayed on the display panel, the gate driver simultaneously supplies gate pulses to two gate lines that are spaced apart with two other gate lines interposed between the two gate lines.

2. The stereoscopic image display apparatus of claim 1, wherein sub-pixels are provided in the display panel, and nine sub-pixels arranged in a 3×3 form among the sub-pixels are a pixel that display one sub-image.

3. The stereoscopic image display apparatus of claim 2, wherein the nine sub-pixels are at positions corresponding to a convex lens included in the lens unit.

4. The stereoscopic image display apparatus of claim 3, wherein the nine sub-pixels include three first sub-pixels, three second sub-pixels, and three third sub-pixels, and the convex lens extends along a first direction that is different from a direction in which the gate lines extend.

5. The stereoscopic image display apparatus of claim 4, wherein among the three first sub-pixels, a 1ath subpixel is on a first side of the convex lens, a 1 cth subpixel is on a second side opposite to the first side with respect to a longitudinal direction of the convex lens, and a 1bth subpixel is between the 1ath subpixel and the 1 bth subpixel.

6. The stereoscopic image display apparatus of claim 2, wherein the pixel includes three first sub-pixels, three second sub-pixels, and three third sub-pixels, and
the three first sub-pixels are connected to different gate lines.

7. The stereoscopic image display apparatus of claim 2, wherein during a planar image display period in which a planar image is displayed on the display panel, a planar sub-image is output from the pixel, and
during the stereoscopic image display period, the same stereoscopic sub-images are output from two pixels adjacent along a first direction that is different from a direction in which the gate lines extend.

8. The stereoscopic image display apparatus of claim 2, wherein during a planar image display period in which a planar image is displayed on the display panel, first data voltages having a same level are supplied to three first sub-pixels in the pixel, second data voltages having a same level are supplied to three second sub-pixels in the pixel, and third data voltages having a same level are supplied to three third sub-pixels in the pixel.

9. The stereoscopic image display apparatus of claim 2, wherein during the stereoscopic image display period, first data voltages having different levels are supplied to three first sub-pixels in the pixel, second data voltages having different levels are supplied to three second sub-pixels in the pixel, and third data voltages having different levels are supplied to three third sub-pixels in the pixel.

10. The stereoscopic image display apparatus of claim 2, wherein a first gate line to a third gate line are connected to a first pixel among pixels in the display panel, and a fourth gate line to a sixth gate line are connected to a second pixel adjacent to the first pixel along a first direction that is different from a direction in which the gate lines extend.

11. The stereoscopic image display apparatus of claim 10, wherein during the stereoscopic image display period, the gate driver simultaneously supplies gate pulses to the first gate line and the fourth gate line, the gate driver simultaneously supplies gate pulses to the second gate line and the fifth gate line, and the gate driver simultaneously supplies gate pulses to the third gate line and the sixth gate line.

12. The stereoscopic image display apparatus of claim 1, wherein the gate driver comprises:
stages outputting gate pulses; and
switching units including a switching unit corresponding to a (6n−2)th stage (n is a natural number of 2 or more) that comprises:
a first switch connecting the (6n−2)th stage to a (6n−3)th stage; and
a second switch connecting the (6n−2)th stage to a (6n−6)th stage.

13. The stereoscopic image display apparatus of claim 12, wherein among the switching units, a switching unit corresponding to a fourth stage comprises:
a first switch connecting the fourth stage to a third stage; and
a second switch connecting a control driver to the fourth stage, the control driver supplying a start signal.

14. The stereoscopic image display apparatus of claim 1, wherein the gate driver comprises:
stages outputting gate pulses; and
switching units including a switching unit corresponding to a (6n−2)th stage (n is a natural number of 2 or more) that connects the (6n−2)th stage to a (6n−3)th stage or a (6n−6)th stage.

15. The stereoscopic image display apparatus of claim 14, wherein among the switching units, a switching unit corresponding to a fourth stage connects the fourth stage to a third stage or connects a control driver to the fourth stage,
wherein the control driver supplies a start signal.

16. The stereoscopic image display apparatus of claim 14, wherein the switching unit corresponding to the (6n−2)th stage supplies a carry signal output from the (6n−3)th stage to the (6n−2)th stage or supplies a carry signal output from the (6n−6)th stage to the (6n−2)th stage.

17. The stereoscopic image display apparatus of claim 16, wherein among the switching units, a switching unit corresponding to a fourth stage supplies a carry signal output from a third stage to the fourth stage or supplies a start signal, which is supplied from a control driver to a first stage, to the fourth stage.

18. The stereoscopic image display apparatus of claim 14, wherein a switching unit corresponding to the (6n−2)th stage connects the (6n−2)th stage to the (6n−3)th stage during a planar image display period in which a planar image is displayed in the display panel, and connects the (6n−2)th stage to the (6n−6)th stage during the stereoscopic image display period.

19. The stereoscopic image display apparatus of claim 18, wherein among the switching units, a switching unit corresponding to a fourth stage connects the fourth stage to a third stage during a planar image display period in which a planar image is displayed in the display panel, and connects the fourth stage to a control driver during the stereoscopic image display period,
wherein the control driver supplies a start signal.
